(19) United States
(12) Patent Application Publication
(10) Pub. No.: US 2026/0359797 A1
(43) Pub. Date: Nov. 12, 2026

(54) SYSTEM AND METHOD FOR EXECUTING A DIGITAL TRANSACTION USING A VIRTUAL CURRENCY

(71) Applicant: Transactix Financial Inc., Kitchener (CA)

(72) Inventors: Abbas Abou Daya, Vancouver (CA); Ali Abou Daya, Toronto (CA)

(21) Appl. No.: 19/673,639

(22) Filed: May 11, 2026

Related U.S. Application Data
(60) Provisional application No. 63/804,132, filed on May 12, 2025.

(51) Int. Cl. G06Q 20/06; G06Q 20/10; G06Q 20/32; G06Q 20/36; G06Q 20/40

(52) U.S. Cl. CPC G06Q 20/065; G06Q 20/108; G06Q 20/3276; G06Q 20/36; G06Q 20/4016

(57) ABSTRACT

A system and method for executing a digital transaction using a virtual currency is provided herein. The system includes a payment request module for generating payment request data based on the digital transaction, a code generation module for generating a scannable identifier based on the payment request data, a scanning device for scanning the scannable identifier and obtaining the payment request data, a transaction execution module for executing the transaction in the virtual currency based on the payment request data, the transaction execution module further for updating balances of a database based on the payment request data and the virtual currency.

### TECHNICAL FIELD

The following relates generally to payment systems, and more particularly to systems and methods for executing a digital transaction using a virtual currency.

### Introduction

Modern payment systems rely heavily on traditional financial institutions, credit card networks, and centralized intermediaries to process transactions. These systems often involve multiple layers of authorization, settlement delays, and high transaction fees—particularly for small merchants or cross-border transactions. Additionally, real-time fund transfers are not uniformly available across platforms, limiting instant access to transferred funds. These inefficiencies are compounded by the lack of interoperability between payment platforms and limited support for micropayments or alternative payment mechanisms. As consumer demand grows for faster, lower-cost, and more flexible payment options, there is an unmet need for a secure and efficient method of transferring value that bypasses conventional banking infrastructure.

Accordingly, there is a need for an improved system and method for executing a digital transaction using a virtual currency that overcomes at least some of the disadvantages of existing systems and methods.

### SUMMARY

In one aspect, there is provided a system for executing a digital transaction using a virtual currency, comprising a payment request module for generating payment request data based on the digital transaction, a code generation module for generating a scannable identifier based on the payment request data, a scanning device for scanning the scannable identifier and obtaining the payment request data, and a transaction execution module for executing the transaction in the virtual currency based on the payment request data and for updating balances of a data-base based on the payment request data and the virtual currency.

In an embodiment, scanning the scannable identifier displays the payment request data in a payment application.

In an embodiment, the payment request data includes an amount and an order ID.

In an embodiment, the system further includes a compliance module for checking for compliance and fraud of the transaction.

In an embodiment, the compliance module checks for compliance and fraud using the amount and the order ID.

In an embodiment, the compliance module generates a compliance check based on the check for compliance and fraud.

In an embodiment, the code generation module generates the scannable identifier using the amount, the order ID, and the compliance check.

In an embodiment, the scannable identifier includes a time, wherein the time is the time that the scannable identifier is generated.

In an embodiment, the scannable identifier is an invoice corresponding to products.

In an embodiment, the system further includes a payment review module for reviewing the payment request data.

In an embodiment, the payment review module displays a review payment information button and a confirm payment information button on a device.

In an embodiment, the check for compliance and fraud includes balance checks and anti-fraud checks.

In an embodiment, the database includes a local ledger or a distributed ledger.

In another aspect, there is provided a method for executing a digital transaction using a virtual currency, comprising generating a payment request and specifying an amount using an application, creating an unsigned transaction based on the payment request, checking the unsigned transaction for compliance and fraud, generating a scannable identifier of the checked unsigned transaction, scanning the scannable identifier and displaying the payment request in the application, reviewing and confirming the payment request, signing the transaction, executing the transaction using the virtual currency, and confirming the transaction, and reconciling balances of a database based on the transaction and the virtual currency.

In another aspect, there is provided a system for executing a deposit using a virtual currency, comprising a deposit request device for sending a deposit request to a financial institution, the deposit request including instructions for transferring funds, a fund deposit module for depositing the funds to an account, a mint module for generating the virtual currency, wherein the virtual currency is generated in an amount corresponding to the funds, and a transfer module for transferring the virtual currency to a digital wallet of the user.

In another aspect, there is provided a method of executing a deposit using a virtual currency, comprising initiating a deposit request to a financial institution, transferring funds from the financial institution based on the deposit request, generating the virtual currency in an amount corresponding to the funds, and transferring the virtual currency to a digital wallet.

In an embodiment, the transfer is initiated through a bank application of the user.

In an embodiment, the deposit request device one of: includes the digital wallet; and is separate from the digital wallet.

In an embodiment, the fund deposit module provides a mint request to the mint module based on the funds.

In an embodiment, the account corresponds to an identification of the deposit request device.

In another aspect, there is provided a system for executing a withdrawal using a virtual currency, comprising a withdrawal request device for transferring a virtual currency to a burn address, a blockchain search module for confirming transfer of the virtual currency to the burn address and generating a confirmation, and a fund transfer module for transferring funds corresponding to the virtual currency to a financial institution based on the confirmation.

In another aspect, there is provided a method for executing a withdrawal using a virtual currency, comprising transferring the virtual currency to a burn address, confirming transfer of the virtual currency to the burn address, and transferring funds corresponding to the virtual currency to a financial institution.

In an embodiment, the virtual currency is burned by a burn module.

Other aspects and features will become apparent to those ordinarily skilled in the art upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a system for executing a digital transaction using a virtual currency, according to an embodiment;

FIG. 2 is a flowchart of a method for executing a digital transaction using a virtual currency, according to an embodiment;

FIG. 3 is a schematic diagram of a system for depositing a digital currency into the system of FIG. 1, according to an embodiment;

FIG. 4 is a flowchart of a method of depositing a digital currency into the system of FIG. 1, according to an embodiment;

FIG. 5 is a schematic diagram of a system for withdrawing a digital currency from the system of FIG. 1, according to an embodiment;

FIG. 6 is a flowchart of a method of withdrawing a digital currency from the system of FIG. 1, according to an embodiment; and

FIG. 7 is a block diagram of a computing device of the present disclosure, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and / or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device / article (whether or not they cooperate) may be used in place of a single device / article. Similarly, where more than one device or article is described herein (whether or not they cooperate), it will be readily apparent that a single device / article may be used in place of the more than one device or article.

The following relates generally to payment systems, and more particularly to systems and methods for executing a digital transaction using a virtual currency.

Conventional systems for processing digital transactions typically rely on rule-based fraud filters or manual verification of device identity and transaction validity, which can be error-prone, slow, and vulnerable to circumvention. Such conventional systems often lack contextual awareness and the ability to dynamically assess blockchain-related transaction state or environmental factors such as time and location. The systems and methods described herein improve computer functionality by performing compliance and fraud checks before authorizing execution of a digital currency transfer. In particular, the systems and methods described herein allow a computer to dynamically detect suspicious behavior or incomplete transaction conditions in real time, thereby improving digital transaction integrity by detecting, preventing, and reducing fraudulent transfers. Accordingly, the present disclosure provides improved computer systems and methods for accurately handling and transmitting data associated with digital transactions.

Furthermore, conventional systems for transmitting and executing digital transactions disadvantageously present inefficiencies due to repeated database queries, lack of synchronization between systems, and delays associated with confirming blockchain activity. These limitations can lead to increased network traffic, delayed user experience, and inconsistent transaction states across distributed devices. The systems and methods described herein improve computer functionality by optimizing the transmission, validation, and execution of digital currency transactions. The systems and methods described herein improve computer functionality by transmitting only context-relevant metadata—such as digital wallet addresses, geolocation, time stamps, and order IDs—between devices, and by locally verifying digital transaction state before blockchain confirmation. Accordingly, the systems and methods described herein reduce latency, minimize resource consumption, and improve the responsiveness and reliability of blockchain-based digital transaction execution.

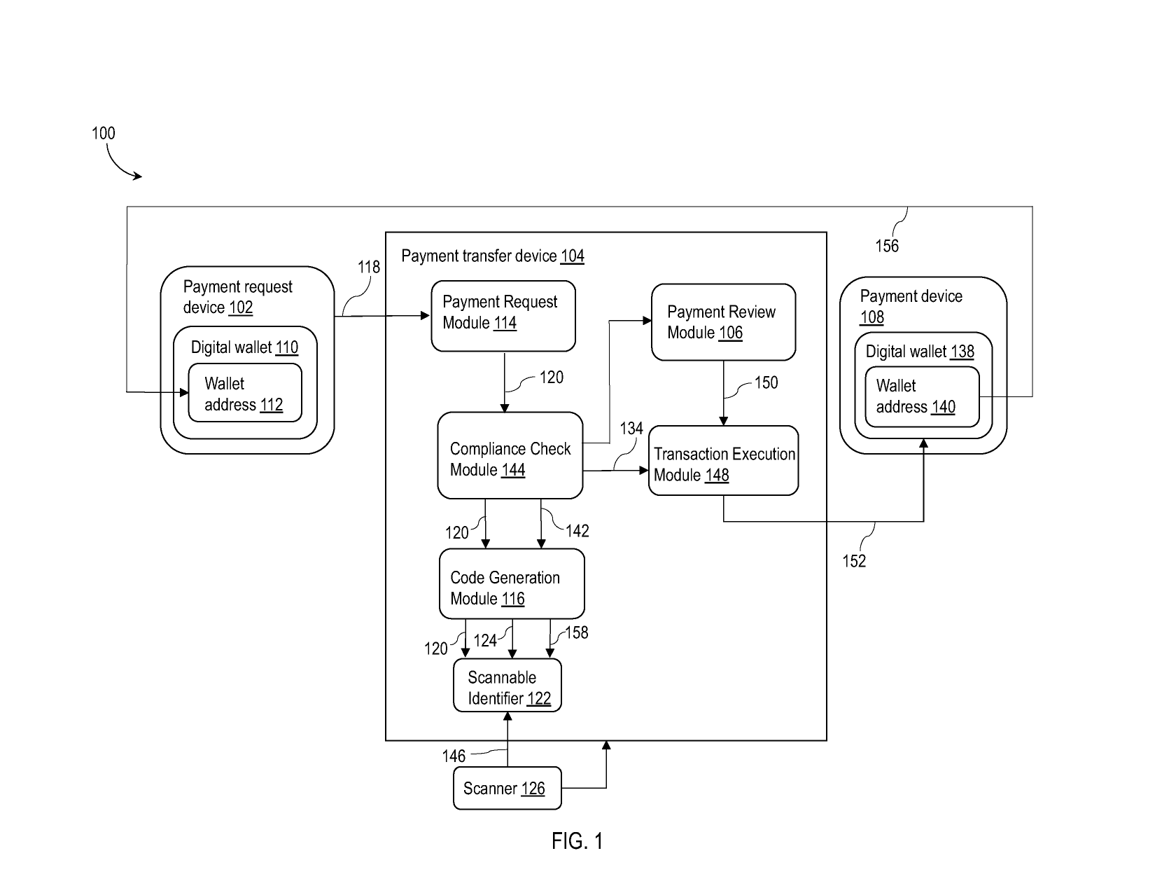

Referring now to FIG. 1, shown therein is a system 100 for executing a digital transaction using a virtual currency, according to an embodiment.

The system 100 includes a payment request device 102. The system 100 further includes a payment device 108. Generally, the payment request device 102 is configured to generate a payment request, and the payment device 108 is configured to provide payment for the payment request.

The payment request device 102 includes a digital wallet 110. The digital wallet 110 stores security information of one or more digital wallet addresses for transacting on a blockchain. The blockchain may be a distributed ledger that stores information of digital transactions. In the embodiment provided in FIG. 1, both the payment request device 102 and the payment device 108 include a digital wallet. In other embodiments, either the payment request device 102 or the payment device 108 may include a digital wallet. A digital wallet may be, for example, a device, physical medium, program, or online service which stores security information for digital transactions. A digital transaction may include a transaction involving the use of a digital currency. The digital currency may be any suitable digital representation of value that may be accepted as a means of payment. In an embodiment, the digital currency may be a virtual currency. In an embodiment, the virtual currency may be a cryptocurrency.

The digital wallet 110 includes a wallet address 112 for sending and receiving a digital currency. The wallet address 112 is a unique identifier that identifies an entity sending or receiving the digital currency.

The system 100 further includes a payment transfer device 104 (also referred to as the transfer device 104). The transfer device 104 creates a digital transaction based on a payment request (such as payment request 118 in FIG. 1) generated by the payment request device 102. The digital transaction may be an unsigned transaction.

The payment transfer device 104 includes a payment request module 114. The payment request module 114 receives the payment request 118 from the payment request device 102. The payment request module 114 generates an order ID 120 based on the payment request 118. The payment request 118 includes an amount of payment being requested by the payment request device 102. In an embodiment, the payment request 118 may include order data corresponding to items being sold by an operator of the payment request module 114 to an operator of the payment device 108. The payment request module 144 provides the order ID 120 to a compliance check module 144.

The payment transfer device 104 includes the compliance check module 144. The compliance check module 144 checks for compliance and fraud of the digital transaction and generates a compliance check 142. The compliance check module 144 checks for compliance and fraud based on, for example, the order ID 120, a time of day, a geolocation, digital wallet addresses (such as, for example, wallet address 112 and wallet address 140), an identifier of the payment request device 102, or an identifier of the payment device 108. In an embodiment, the compliance check module 144 checks for compliance and fraud using AI-based methods for identifying anomalies related to compliance and fraud. The compliance check module 144 provides the order ID 120 and the compliance check 142 to a code generation module 116.

The payment transfer device 104 includes the code generation module 116. The code generation module 116 receives the order ID 120 and the compliance check 142. The code generation module 116 generates a scannable identifier 122 based on the order ID 120. In an embodiment, the code generation module 116 generates the scannable identifier 122 based on the order ID 120 and the compliance check 142. In an embodiment, the scannable identifier 122 may be a two-dimensional code. The two-dimensional code may be, for example, a Quick-Response (QR) code. In another embodiment, the scannable identifier 122 may be a near-field communication (NFC) signal. The NFC signal may be based on inductive coupling using electromagnetic coils present on the payment request device 102 or the payment device 108.

The scannable identifier 122 includes the order ID 120, an amount 158 based on the order ID 120, and a generation time 124. The generation time 124 may be the time that the scannable identifier 122 is generated by the code generation module 116. In an embodiment, the scannable identifier 122 may include an invoice corresponding to goods or services being provided by an operator of the payment request device 102 to an operator of the payment device 108.

The payment transfer device 104 may display the scannable identifier 122 on the payment request device 102. The system 100 includes a scanner 126 for taking a scan 146 of the scannable identifier 122. In an embodiment, the scanner 126 may be a camera. In another embodiment, the scanner 126 may be an NFC reader.

The payment transfer device 104 includes a payment review module 106. The payment review module 106 may display information of the scannable identifier 122 in the transfer device 104 of the scanner 126 when the scannable identifier 122 is scanned by the scanner 126. The transfer device 104 further provides the order ID 120, the amount 158, and the generation time 124 of the scannable identifier 122 to the compliance check module 144 to check for compliance and fraud of the scannable identifier 122. In an embodiment, the payment device 108 includes the scanner 126.

The information displayed by the payment review module 106 may include, as examples, an identifier of the payment request device 102, whether the payment request device 102 is a trusted or verified entity, items included in the payment request 118, or the amount 158. The payment review module 106 further provides a confirmation mechanism to confirm the digital transaction and generate a confirmation 150. The confirmation mechanism allows the payment device 108 to confirm the digital transaction and pay the amount 158. In an embodiment, the confirmation mechanism may be, for example, a confirmation button for an operator of the payment device 108 to confirm the transaction and pay the amount 158. The confirmation mechanism may be displayed on the payment device 108. The payment review module provides the confirmation 150 to a transaction execution module 148.

The payment transfer device 104 conducts a plurality of verification checks 134 on the payment device 108 by the compliance check module 144. The verification checks 134 may include balance checks and anti-fraud checks of the digital wallet 138. The verification checks 134 may further include confirmation that actions have been effectuated on the blockchain and that a sufficient amount of time has passed. The verification checks 134 may further include confirmation of block-finality on the blockchain. The verification checks 134 may further include a state of the digital transaction, the amount of time since the digital transaction is seen on the blockchain, or the number of blocks mined since the digital transaction is seen on the blockchain. The compliance check module 144 provides the verification checks 134 to the transaction execution module 148.

The payment transfer device 104 includes the transaction execution module 148. The transaction execution module 148 executes the digital transaction. The transaction execution module 148 may execute the digital transaction once sufficient blocks have passed on the blockchain. The transaction execution module 148 executes the digital transaction based on the confirmation 150 and the verification checks 134. The transaction execution module 148 may execute the digital transaction by signing the transaction. The transaction execution module 148 may further execute the digital transaction by executing the transaction in a virtual currency. The transaction execution module 148 may further execute the digital transaction by confirming the digital transaction on the blockchain. The transaction execution module 148 may revert the digital transaction where the digital transaction is not confirmed. In an embodiment, the virtual currency may be any suitable digital representation of value that may be accepted as a means of payment. The transaction execution module 148 may execute the transaction in the virtual currency by any blockchain-based token transfer process. In an embodiment, the blockchain-based token transfer process may include calling a smart contract on the blockchain to transfer the virtual currency from one wallet address to a second wallet address.

The transaction execution module 148 further accesses the blockchain to record the confirmed digital transaction. The blockchain may be on a local or distributed ledger. The local or distributed ledger may be, as an example, a cold wallet or a hot wallet. The blockchain may further be on a hardware wallet or a cloud multi-sig wallet.

The transaction execution module 148 further provides a transfer command 152 to the payment device 108. The transfer command 152 may call a smart contract on the blockchain to transfer the virtual currency from the wallet address 140 to the wallet address 112.

In the embodiment of FIG. 1, the transaction execution module 148 provides the transfer command 152 to the payment device 108 to transfer a virtual currency 156 from the wallet address 140 to the wallet address 112. In another embodiment, the transfer device 104 may act as escrow for the transfer of the virtual currency 156. In such embodiment, the transfer device 104 may include privacy-preserving features for the payment device 108. The privacy-preserving features may include generating a digital wallet address for the payment device 108 in the transfer device 104. The privacy-preserving features may further include attaching an identification (ID) to the transfer of the virtual currency, wherein the ID tracks all movement of the virtual currency for a particular payment device 108.

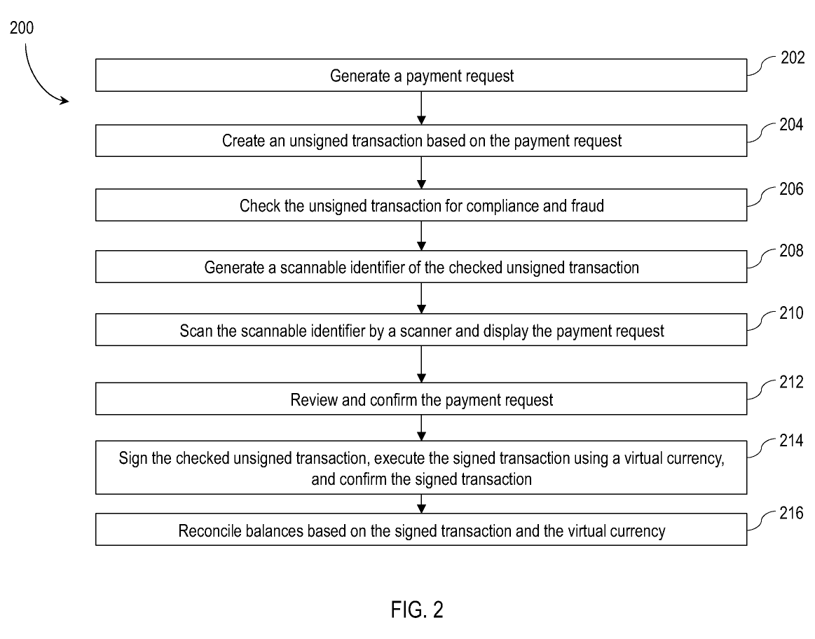

Referring now to FIG. 2, shown therein is a method 200 for executing a digital transaction using a virtual currency, according to an embodiment.

At 202, the method 200 includes generating a payment request.

At 204, the method 200 includes creating an unsigned transaction based on the payment request.

At 206, the method 200 includes checking the unsigned transaction for compliance and fraud.

At 208, the method 200 includes generating a scannable identifier of the checked unsigned transaction.

At 210, the method 200 includes scanning the scannable identifier by a scanner and displaying the payment request based on the scannable identifier. In an embodiment, scanning the scannable identifier directs the scanner to a payment application.

At 212, the method 200 includes reviewing and confirming the payment request.

At 214, the method 200 includes signing the checked unsigned transaction, executing the signed transaction in a virtual currency, and confirming the signed transaction.

At 216, the method 200 includes reconciling balances based on the signed transaction and the virtual currency.

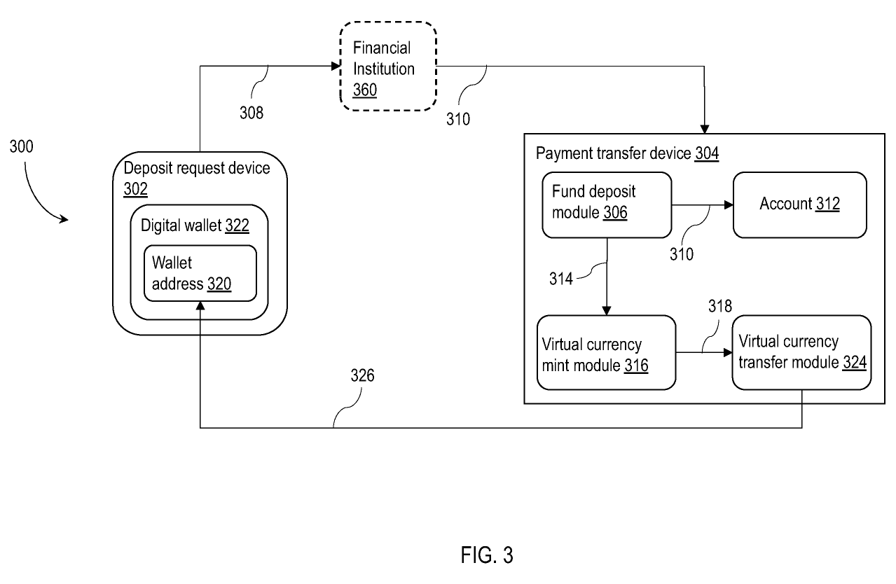

Referring now to FIG. 3, shown therein is a system 300 for depositing a digital currency into the system 100 of FIG. 1, according to an embodiment.

The system 300 includes a deposit request device 302. The deposit request device 302 may be, for example, the payment request device 102 or the payment device 108 of FIG. 1. In the present embodiment, the deposit request device 302 includes a digital wallet 322. In other embodiments, the digital wallet 322 may be a device separate from the deposit request device 302.

The deposit request device 302 sends a deposit request 308 to a financial institution 360. The deposit request 308 includes instructions for transferring an amount of funds 310 from the financial institution to a payment transfer device 304. The funds 310 may be any suitable representation of value that may be accepted as a means of payment. In an embodiment, the funds 310 may be, for example, a digital currency. In an embodiment, the financial institution 360 may use Interac™ to transfer the funds 310 to the payment transfer device 304. The financial institution 360 is provided with a dashed box to indicate that the financial institution 360 is external to the system 300.

The system 300 includes the payment transfer device 304. The payment transfer device 304 is an embodiment of the payment transfer device 104 of FIG. 1. The payment transfer device 304 provides the funds 310 to a fund deposit module 306.

The payment transfer device includes the fund deposit module 306. The fund deposit module 306 transfers the funds 310 to an account 312. The account 312 may correspond to an identification of the deposit request device 302. The fund deposit module 306 further provides a mint request 314 to a virtual currency mint module 316 based on the funds 310.

The virtual currency mint module 316 mints a virtual currency based on the mint request 314. The virtual currency may be a cryptocurrency. The mint module 316 mints the virtual currency by calling a smart contract function. In an embodiment, the mint module 316 may perform batch minting. In such an embodiment, the mint module 316 may mint the virtual currency in batches of any number of units of the virtual currency. In an embodiment, the mint module 316 mints the virtual currency in batches of at least 1 million units. The mint module 316 provides a transfer request 318 to a virtual currency transfer module 324 to transfer the virtual currency. The virtual currency transfer module 324 transfers minted virtual currency 326 to the digital wallet 322.

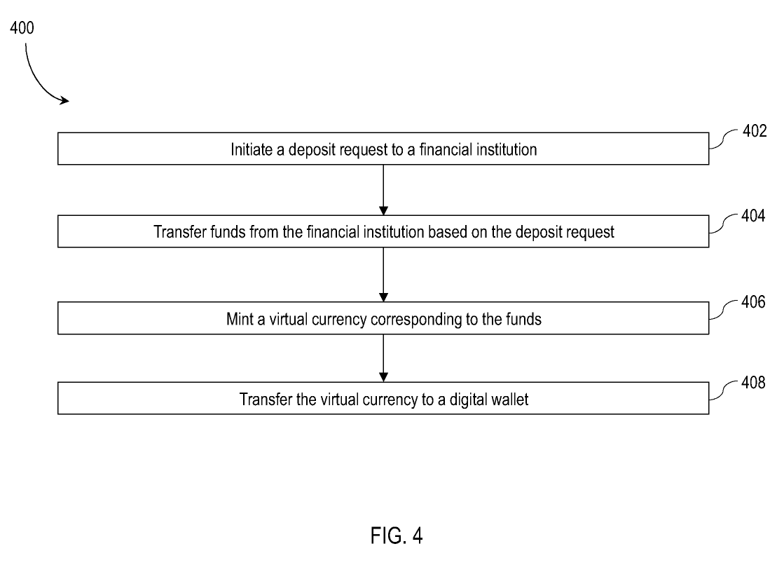

Referring now to FIG. 4, shown therein is a method 400 for depositing a digital currency into the system 100 of FIG. 1, according to an embodiment.

At 402, the method 400 includes initiating a deposit request to a financial institution.

At 404, the method 400 includes transferring funds based on the deposit request.

At 406, the method 400 includes minting a virtual currency corresponding to the funds.

At 408, the method 400 includes transferring the virtual currency to a digital wallet.

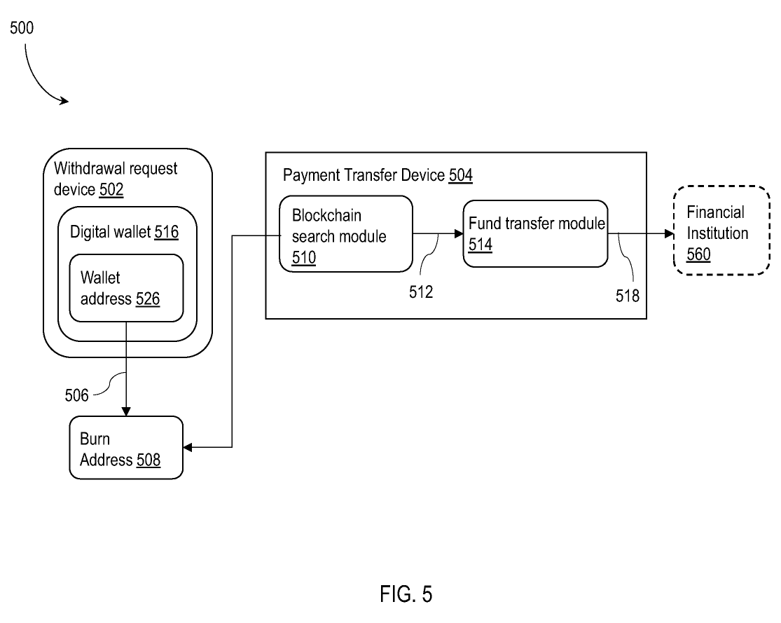

Referring now to FIG. 5, shown therein is a system 500 for withdrawing a digital currency from the system 100 of FIG. 1, according to an embodiment.

The system 500 includes a withdrawal request device 502. The withdrawal request device 502 may be, for example, the payment request device 102 or the payment device 108 of FIG. 1. In the present embodiment, the withdrawal request device 502 includes a digital wallet 516. In other embodiments, the digital wallet 516 may be a device separate from the withdrawal request device 502.

In general, the withdrawal request device 502 may be provided with a burn address that the device 502 may send a virtual currency to. When the device 502 sends the virtual currency to the burn address, a payment transfer device 504 (an embodiment of the payment transfer device 104 of FIG. 1) transfers an amount equivalent to the virtual currency to a default withdrawal entity of the withdrawal request device 502. The default withdrawal entity may be a financial institution, such as financial institution 560. In an embodiment, the financial institution 560 may be a bank. In an embodiment, the default withdrawal entity may be of an operator of the withdrawal request device 502.

In the embodiment presented in FIG. 5, the withdrawal request device 502 sends a virtual currency 506 to a burn address 508.

The payment transfer device 504 includes a blockchain search module 510. The blockchain search module 510 determines whether transfer of the virtual currency 506 to the burn address 508 is completed on a blockchain. The blockchain search module 510 generates a confirmation 512 of the transfer.

The blockchain search module 510 provides the confirmation 512 to a fund transfer module 514. The fund transfer module 514 attributes the virtual currency 506 back to the digital wallet 516 of the withdrawal request device 502. The fund transfer module 514 attributes the virtual currency 506 to the digital wallet 516 based on the blockchain transaction confirmed by the blockchain search module 510.

The fund transfer module 514 further transfers funds 518 corresponding to the virtual currency 506. The fund transfer module 514 may transfer the funds 518 to the financial institution 560. The fund transfer module 514 may transfer the funds 518 using, for example, wire transfer or Interac.

In another embodiment, the withdrawal request device 502 uses the payment transfer device 504 to transfer the virtual currency 506 to the burn address 508. In such embodiment, the payment transfer device 504 includes internal database accounting for tracking the virtual currency 506 corresponding to ownership of the virtual currency 506 by an identifier of the withdrawal request device 502.

In another embodiment, the withdrawal request device 502 may interface with the payment transfer device 504 without the digital wallet 516. In such embodiment, the payment transfer device 504 further includes a burn module (not shown) for burning the virtual currency 506. The burn module may advantageously enable batch burning of the virtual currency 506.

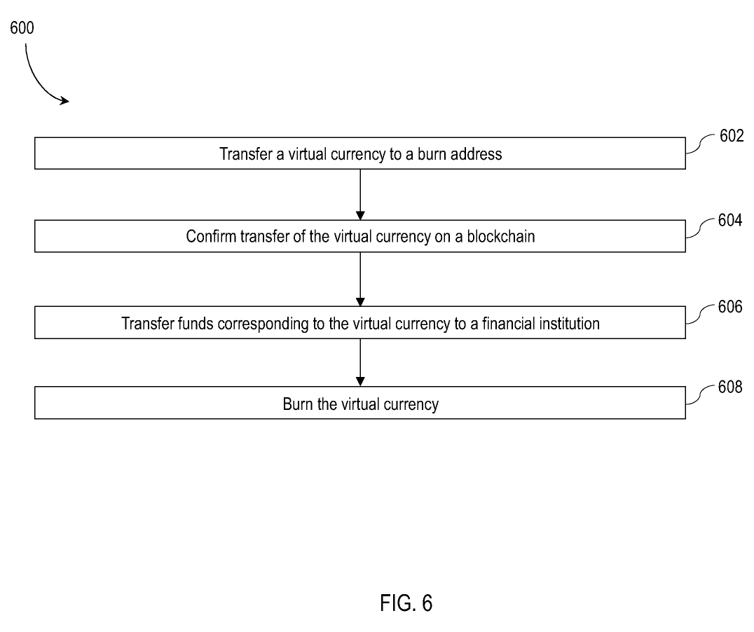

Referring now to FIG. 6, shown there is a method 600 for withdrawing a digital currency from the system 100 of FIG. 1, according to an embodiment.

At 602, the method 600 includes transferring a virtual currency to a burn address.

At 604, the method 600 includes confirming transfer of the virtual currency on a blockchain.

At 606, the method 600 includes transferring funds corresponding to the virtual currency to a financial institution.

At 608, the method 600 includes burning the virtual currency.

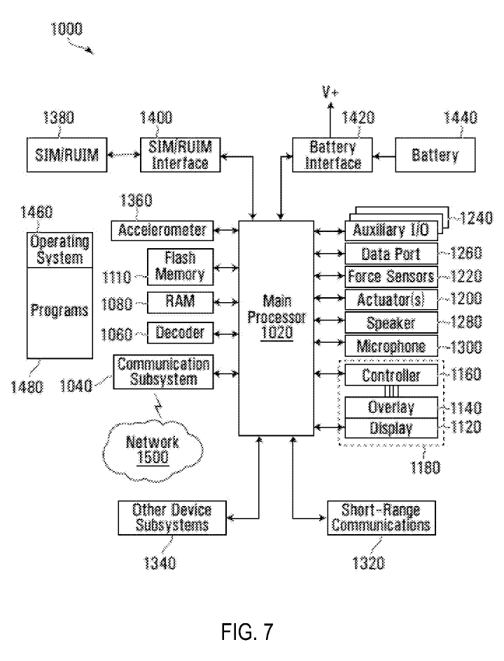

Referring now to FIG. 7, shown therein is a block diagram of a computing device 1000 of the payment transfer device 104 of FIG. 1, according to an embodiment. The computing device 1000 may be or may implement, for example, any one of the payment transfer device 104 of FIG. 1, payment transfer device 304 of FIG. 3, and payment transfer device 504 of FIG. 5.

The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and send messages to a wireless network 1500. The payment transfer device 104 may advantageously improve functioning of the processor 1020 by minimizing redundant compliance checks. Fewer redundant compliance checks may advantageously result in reduced CPU cycles and reduced thermal load of the processor 1020.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440. The payment transfer device 104 may advantageously improve functioning of the batteries 1440 by reducing CPU cycles and thermal load of the processor 1020. Reduced CPU cycles and thermal load of the processor 1020 may advantageously result in extended functioning time and reduced thermal stress of the batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a computing device generated by the processor 102 may be displayed on the touch-sensitive display 118.

The processor 1020 may also interact with an accelerometer 1360 as shown in FIG. 1. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The computing device 1000 also includes an operating system 1460 and software components 1480 that are executed by the processor 1020 and which may be stored in a persistent data storage device such as the flash memory 1100. Additional applications may be loaded onto the computing device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the computing device 1000 may be similar. The speaker 1280 may output audible information converted from electrical signals, and the microphone 1300 may convert audible information into electrical signals for processing.

While the above description provides examples of one or more apparatus, methods, or systems, it will be appreciated that other apparatus, methods, or systems may be within the scope of the claims as interpreted by one of skill in the art.

1. A system for executing a digital transaction using a virtual currency, the system comprising at least one processor and at least one non-transitory memory storing instructions for execution by the at least one processor to implement:
a payment request module for generating payment request data based on the digital transaction;
a code generation module for generating a scannable identifier based on the payment request data;
a scanning device for scanning the scannable identifier and obtaining the payment request data;
a transaction execution module for executing the transaction in the virtual currency based on the payment request data; and
the transaction execution module further for updating balances of a database based on the payment request data and the virtual currency.

2. The system of claim 1, wherein scanning the scannable identifier displays the payment request data in a payment application.

3. The system of claim 1, wherein the payment request data includes an amount and an order ID.

4. The system of claim 1, further comprising a compliance module for checking for compliance and fraud of the transaction.

5. The system of claim 4, wherein the compliance module checks for compliance and fraud using the amount and the order ID.

6. The system of claim 5, wherein the compliance module generates a compliance check based on the check for compliance and fraud.

7. The system of claim 6, wherein the code generation module generates the scannable identifier using the amount, the order ID, and the compliance check.

8. The system of claim 1, wherein the scannable identifier includes a time, wherein the time is the time that the scannable identifier is generated.

9. The system of claim 1, wherein the scannable identifier is an invoice corresponding to products.

10. The system of claim 1, further comprising a payment review module for reviewing the payment request data.

11. The system of claim 10, wherein the payment review module displays a review payment information button and a confirm payment information button on a device.

12. The system of claim 4, wherein the check for compliance and fraud includes balance checks and anti-fraud checks.

13. The system of claim 1, wherein the database includes a local ledger or a distributed ledger.

14. A system for executing a deposit using a virtual currency, the system comprising at least one processor and at least one non-transitory memory storing instructions for execution by the at least one processor to implement:
a deposit request device for sending a deposit request to a financial institution, the deposit request including instructions for transferring funds;
a fund deposit module for depositing the funds to an account; and
a mint module for generating the virtual currency, wherein the virtual currency is generated in an amount corresponding to the funds;
a transfer module for transferring the virtual currency to a digital wallet of a user.

15. The system of claim 14, wherein the transfer is initiated through a bank application of the user.

16. The system of claim 14, wherein the deposit request device one of: includes the digital wallet; and is separate from the digital wallet.

17. The system of claim 14, wherein the fund deposit module provides a mint request to the mint module based on the funds.

18. The system of claim 14, wherein the account corresponds to an identification of the deposit request device.

19. A system for executing a withdrawal using a virtual currency, the system comprising at least one processor and at least one non-transitory memory storing instructions for execution by the at least one processor to implement:
a withdrawal request device for transferring a virtual currency to a burn address;
a blockchain search module for confirming transfer of the virtual currency to the burn address and generating a confirmation; and
a fund transfer module for transferring funds corresponding to the virtual currency to a financial institution based on the confirmation.

20. The system of claim 19, wherein the virtual currency is burned by a burn module.
